(19) United States
(12) Patent Application Publication
(10) Pub. No.: US 2020/0094523 A1
(43) Pub. Date: Mar. 26, 2020

(54) STRUCTURED CERAMIC COMPOSITES MODELED AFTER NATURAL MATERIALS AND MADE VIA COLD SINTERING

(71) Applicant: SABIC Global Technologies B.V., Bergen op Zoom (NL)

(72) Inventor: Devendra BAJAJ, Evansville, IN (US)

(21) Appl. No.: 16/469,417

(22) PCT Filed: Dec. 15, 2017
(86) PCT No.: PCT/US2017/066777

§ 371 Date: Jun. 13, 2019

Related U.S. Application Data
(60) Provisional application No. 62/435,187, filed on Dec. 16, 2016.

(51) Int. Cl. B32B 9/00; B32B 9/04; B32B 7/12; B32B 3/12; B29C 70/64

(52) U.S. Cl. CPC B32B 9/005; B32B 9/045; B29C 70/64; B32B 3/12; B32B 7/12

(57) ABSTRACT

Described herein are single- and multi-layer cold-sintered ceramic composites and processes for making them from inorganic compounds embedded within the cells of open cell non-ceramic substrates. The cold sintering process and diversity of microarchitectures based upon the open cell substrates allow the manufacture of a wide variety of single- and multi-layer cold-sintered ceramic composites with superior strength, toughness, and resistance to crack propagation.

### PRIORITY

This application claims the benefit of priority to U.S. Provisional Patent Application Ser. No. 62/435,187, filed on Dec. 16, 2016, the benefit of priority of each of which is claimed hereby, and each of which is incorporated by reference herein in its entirety.

### BACKGROUND

Many ceramic and composite materials are sintered to reduce porosity and to enhance properties of the materials such as strength, electrical conductivity, translucency, and thermal conductivity. Sintering processes involve the application of high temperatures, typically above 1,000° C., to densify and to improve the properties of the materials. However, the use of high sintering temperatures precludes the fabrication of certain types of materials, limits the use of non-ceramic materials, such as polymers, and it increases the expense of fabricating the materials.

Certain low temperature processes for sintering ceramics can address some of the challenges related to high temperature sintering. For example, Ultra Low Temperature Cofired Ceramics (ULTCC) can be fired between 450° C. and 750° C. See, e.g., He et al., “Low-Temperature Sintering Li₂MoO₄/Ni_{0.5}Zn_{0.5}Fe₂O₄ Magneto-Dielectric Composites for High-Frequency Application,” J. Am. Ceram. Soc. 2014:97(8):1-5. In addition, the dielectric properties of Li₂MoO₄ can be improved by moistening water-soluble Li₂MoO₄ powder, compressing it, and post processing the resulting samples at 120° C. See Kahari et al., J. Am. Ceram. Soc. 2015:98(3):687-689. Even so, while the particle size of Li₂MoO₄ powder was less than 180 microns, Kahari teaches that smaller particle sizes complicate the even moistening of the powder, thereby resulting in clay-like clusters, non-uniform density, warpage, and cracking, and ultimately concluding that a large particle size is advantageous.

It is difficult to manufacture ceramic parts of complicated shapes or near finished shapes using conventional sintering processes. Also, it is difficult to make ceramic parts with low brittleness using conventional sintering processes. The high temperature of conventional sintering processes leads to volumetric changes of ceramic materials, thereby making it difficult to control the dimensions and defects that result in brittleness of sintered parts.

Incorporation of non-ceramic materials, such as polymers, during the sintering step can lead to ceramic composite materials (CCMs). Property improvements in CCMs manufactured by mixing together ceramic and non-ceramic materials can be limited mostly to the properties of the constituting materials and their composition (wt % or vol %). In general, the property improvements in such heterogeneous mixtures will be governed by the composites rule of mixtures. Moreover, using conventional techniques in ceramics and composites manufacturing, it is difficult to combine ceramic and non-ceramic materials into ceramic composite materials. This is due to the high temperature (more than 0.5-times the melting temperature of ceramic) that is typically used during the sintering of a ceramic. For non-ceramic materials, such as polymers, the high sintering temperature can result in degradation of the polymer. More challenging is controlling the structure of composites made by combining ceramic and non-ceramic materials.

### SUMMARY

The present disclosure addresses these and other challenges by providing structured cold-sintered ceramic composites and processes for making them. The processes enable the careful tailoring of a non-ceramic microarchitecture, akin to that found in natural materials like nacre, enamel, dentin, bone, wood, and turtle shell, combined with one or more inorganic compounds that can undergo a cold sintering process. The resulting composite possesses high strength and stiffness imposed by cold-sintered inorganic compound(s), and the non-ceramic microarchitecture accounts for toughening, whereby the composite is remarkably resilient to crack propagation.

Thus, in one embodiment, the disclosure provides a process for making a cold-sintered ceramic composite, comprising the steps of:
a. filling a plurality of open cells of an open cell substrate with (1) at least one inorganic compound that is in the form of particles having a number average particle size of less than about 30 μm and (2) a solvent in which the inorganic compound is at least partially soluble to obtain a filled-cell substrate, wherein the open cell substrate is comprised of at least one non-ceramic material; and
b. subjecting the filled-cell substrate to a pressure of no more than about 5000 MPa and a temperature (T₁) that is no greater than 200° C. above the boiling point of the solvent (as determined at 1 bar) to obtain a structured cold-sintered ceramic composite.

Another embodiment is a cold-sintered ceramic composite that is made by the process described herein.

### DETAILED DESCRIPTION

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range. The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

The disclosure provides a structured cold-sintered ceramic polymer composite that is obtained by any of the processes described herein, any one of which is referred to as a Cold Sintering Process (CSP). The sintering processes described herein relate to the thermo-chemical processing of a mixture of ceramic and non-ceramic constituents at low temperatures, compared to those used in traditional ceramic sintering, in acidic, basic, or neutral chemical environments. The CSP includes the presence of one or more solvents that have some degree of reactivity with, or ability to at least partially dissolve, the inorganic compound(s) that are the pre-ceramic materials. Low sintering temperatures of the CSP enables the incorporation of non-ceramic materials prior to the sintering process, incorporation of which is either impossible or difficult to achieve in conventional high temperature sintering processes. The incorporation of non-ceramic components within the sintered ceramic matrix provides several features that are not typical of ceramics, including electrical conductivity, thermal conductivity, flexibility, resistance to crack propagation, different wear performance, different dielectric constant, improved electrical breakdown strength, and/or improved mechanical toughness.

### Open Cell Substrate

In accordance with various embodiments, the process employs an open cell substrate that, in an initial state, has a plurality of open cells. The term “open cell” refers to a hole or cavity in an otherwise solid monolithic substrate material, wherein each cell has substantially parallel sidewalls perpendicular to the openings of the cell. In various embodiments, all open cells have two openings that are disposed opposite to each other. In other embodiments, the majority of open cells have two openings, and the remaining cells have one opening. Exemplary methods of constructing the cells, as described in more detail below, can ensure that all open cells have two openings.

### Shape and Size

The substrate can exist in various sizes, shapes, and dimensions, so long as at least one opening of each open cell is accessible to the environment external to the substrate. In various embodiments, the substrate is in the form of a sheet having top and bottom surfaces and having a thickness of about 0.1 μm to about 1000 μm. Some processes for constructing the substrate, such as additive manufacturing techniques that are described more fully below, can be used to construct substrates with a greater range of thicknesses, such as 0.1 μm to about 2 cm, about 0.1 μm to about 1 cm, and about 0.1 μm to about 5 mm. For some patterns of open cells, as described herein, the cells are arranged such that the sidewalls of each open cell are common to adjacent open cells. The cells have a sidewall height that is equal to the substrate thickness. In some embodiments, the openings of the open cells are coplanar with the top and bottom surfaces of the open cell substrate (i.e., each open cell extends the entire thickness of the substrate).

The open cells, independent of the physical dimensions of the open cell substrate, can exist in various shapes. The shape of an open cell is defined by the cross-sectional shape of each open cell opening that is perpendicular to the open cell sidewalls. In a given open cell substrate, according to some embodiments, the cross-section of each open cell is the same shape. In other embodiments, a given open cell substrate comprises two or more different cross-section shapes. Regardless of shape, an open cell has a diameter, which is defined as the longest distance from one sidewall to another sidewall within the open cell. For instance, the diameter of an open cell having a circular cross-section is the actual diameter. For an open cell having a rectangular cross-section, the diameter is the length of the long side of the rectangle. Thus, one convenient metric that characterizes the open cell substrate is the number average diameter of the open cells within the open cell substrate. According to some embodiments, the number average diameter is a value in the range of about 0.1 μm to about 5000 μm. Values within any subrange also are contemplated, such as 0.1 μm to about 1000 μm, about 0.5 μm to about 700 μm, about 1 μm to about 400 μm, and about 1 μm to about 300 μm.

The open cell substrate also is characterized, according to various embodiments, by the shape and arrangements of open cells within the substrate. Any shape is contemplated and can easily result from one or more of the substrate construction methods discussed below. In some embodiments, for instance, the shape is a 3- to 8-sided polygon. Examples include a triangle, square, rectangle, pentagon, hexagon, heptagon, and octagon. In specific embodiments, the shape is a hexagon.

The shape, dimension, and arrangement of open cells together govern the basic architecture of the open cell substrate. More specifically, in accordance with some embodiments, the open cells are arranged in a repeating pattern. Thus, for instance, the shape is a hexagon and the open cells resemble a honeycomb pattern. Alternatively, the shape is a rectangle, and repeating rectangular open cells can resemble cornrows where the rectangles are long and narrow. In embodiments where the rectangle dimensions are not as extreme, the open cells can be offset with respect to each other in a brick-and-mortar pattern. Square or rectangular shaped open cells that are not offset with respect to each other can give rise to cross-hatch or mesh patterns.

In other embodiments, the open cell shape is a keyhole. Thus, repeating patterns of keyholes can approximate the microstructure of some naturally occurring tooth enamel.

Circular or ellipsoidal open cells, in accordance with some embodiments, also can be arranged in various ways. For instance, circular open cells that are not concentric can be arranged in a wide range of patterns, depending on open cell diameter and spacing between open cells. For instance, one tight arrangement is hexagonal close packed. Alternatively, circular open cells can be concentric, such as in embodiments wherein each open cell is concentric with at least one other open cell. In some embodiments, all open cells are concentric in a given open cell substrate.

In various embodiments, the open cell substrate comprises a mixture of two or more open cell shapes in repeating or random patterns. Thus, one example of concentric circular open cells approximates the osteon-like pattern of natural bone.

### Construction Methodologies

According to some embodiments, the inventive process and the structured cold-sintered ceramic composite that results from the process comprise a step of constructing the open cell substrate. Various construction techniques are known to skilled persons, who are capable of adapting them to achieve the desired architecture of the open cell substrate. In accordance with some embodiments, as described more specifically below, the construction techniques include molding, cutting, milling, and additive manufacturing.

### Molding

For example, the open cell substrate can be constructed by injection molding or compression molding of one or more non-ceramic materials. Molten plastic pellets or powder can be injection molded or compression molded in complex design templates made of metal inserts. The flow of viscous polymers in thin channels can present challenges due to high shear and may therefore impose limitations on minimum open cell sidewall thickness of the open cell substrate that can be produced using injection molding or compression molding. However, nano-molding technologies (NMT) can be used to make thin walled structures. The open cell sidewall thickness can range from 0.1 μm-1000 μm. In exemplary embodiments, open cell substrate materials suitable for injection molding or compression molding include high flow plastics such as polyethylene and polypropylene.

In other embodiments, compression molding can be used to construct the open cell substrate. For instance, polymers can be used to compression mold complex substrates under high temperature and pressure. Because compression molding uses lower pressures than injection molding, compression molding is especially suitable for producing substrates having thinner open cell sidewall thicknesses.

### Cutting and Milling

Various cutting and milling construction methodologies can be used to make the substrate. In accordance with some embodiments, laser cutting is suitable for producing substrates from films and sheets of non-ceramic materials including polymers, metals, and carbon. A Computer Numeric Control (CNC) controlled laser cutter can carve complex patterns in thin films and sheets of non-ceramic materials. A single sheet or multiple sheets stacked together can be cut using a laser cutting process.

Alternatively, some embodiments provide for die cutting construction processes. For instance, a wire die cutter with specific microarchitecture can be designed and used to cut sheets of non-ceramic materials to produce open cell substrates having thicknesses of 0.1 μm-1000 μm.

Milling techniques known to the skilled artisan are also suitable for constructing the substrate. For instance, the substrate can be machined from sheets or blocks of non-ceramic materials using CNC milling

### Additive Manufacturing

In various embodiments, additive manufacturing processes are used to construct the open cell substrate. For example, fused filament fabrication (FFF) can be used to print specific microarchitecture patterns from non-ceramic materials such as polymers. The raw materials can be in the form of filaments or pellets. The materials are deposited on a build platform using a print nozzle. Polymers such as polycarbonate (PC), polyetherimide (PEI), Polyether ether ketone (PEEK), Polyarylsulphones (PSU, PPSU), Acrylonitrile butadiene styrene (ABS), and Polybutylene terephthalate (PBT) are exemplary materials that are suitable for this purpose.

Alternatively, selective laser sintering (SLS) can be used to print specific microarchitectures from non-ceramic materials, such as polymers and metals. In this construction process, the raw materials can be in the form of powders. A laser is used to melt a bed of powder to form a desired shape. Polymers such as polycarbonate (PC), polyetherimide (PEI), Polyether ether ketone (PEEK), Polyarylsulphones (PSU, PPSU), Acrylonitrile butadiene styrene (ABS), Polybutylene terephthalate (PBT), Polyamide are exemplary, as are metals such as steels, aluminum alloys, Inconel, titanium and cobalt chrome.

In other embodiments, stereolithography (SLA) can be used to construct the open cell substrate from photopolymers. In SLA, an ultraviolet (UV) laser is used to draw a design on the surface of a photopolymer vat. The process prompts polymerization of the polymer resulting in a substrate of the desired shape and design.

Inkjet printing, which is frequently referred to as binder jet printing, is another process that can be used to construct the open cell substrate from non-ceramic materials. For instance, an inkjet print head can deposit a liquid binding material on a bed of non-ceramic powder. The binding liquid will bind the powder to form an open cell substrate of desired form and shape.

### Non-Ceramic Materials

The open cell substrate is comprised of at least one non-ceramic material. In accordance with various embodiments, the material is selected from a metal, carbon, polymer, and combinations thereof. The skilled person understands that a choice of substrate material influences, or is influenced by, the particular process for constructing a given substrate, as described hereinabove.

### Metals

In some embodiments, the material is a metal, such as elemental metals, metal oxides, and alloys thereof. Illustrative metals include lithium, beryllium, sodium, magnesium, aluminum, potassium, calcium, scandium, titanium, vanadium, chromium, manganese, iron, cobalt, nickel, copper, zinc, gallium, rubidium, strontium, yttrium, zirconium, niobium, molybdenum, technetium, ruthenium, rhodium, palladium, silver, cadmium, indium, tin, cesium, barium, lanthanum, cerium, praseodymium, neodymium, promethium, samarium, europium, gadolinium, terbium, dysprosium, holmium, erbium, thulium, ytterbium, lutetium, hafnium, tantalum, tungsten, rhenium, osmium, iridium, platinum, gold, mercury, thallium, lead, bismuth, polonium, francium, radium, actinium, thorium, protactinium, uranium, neptunium, plutonium, americium, curium, berkelium, californium, einsteinium, fermium, mendelevium, nobelium, lawrencium, rutherfordium, dubnium, seaborgium, bohrium, hassium, meitnerium, darmstadtium, roentgenium, copernicium, ununtrium, flerovium, ununpentium, and livermorium.

### Carbon

In other embodiments, one or more forms of carbon can comprise the substrate. Various forms of carbon are suitable for use in the disclosure, including graphite, nanotubes, graphene, carbon black, fullerenes, amorphous carbon, pitch, and tar.

### Polymers

Still other embodiments provide for a substrate that is comprised of at least one polymer P₁. A great variety of polymers can be used as a material in constructing the open cell substrate. Polymers suitable for use in the present disclosure are those that are amenable to the temperature and pressures under the reaction conditions of the cold-sintering process described herein, such that the polymer is able to melt, flow, and/or soften to a degree that allows the polymer to fill inter- and intraparticle voids in the sintered ceramic structure within the structured cold-sintered ceramic composite. Polymers satisfying these basic criteria can be referred to generally as non-sinterable polymers.

In contrast, other polymers do not appreciably melt, flow, and/or soften under the cold-sintering conditions described herein. Rather, these polymers can be compressed and densified under external pressure, and they maintain or form granular or fibrous microstructures in the sintering process. Therefore these polymers can be referred to generally as sinterable polymers.

In some embodiments, the polymer has a melting point (Tₘ₁) if the polymer is crystalline or semi-crystalline Some polymers, even if crystalline or semi-crystalline, also possess a glass transition temperature (T_{g1}). However, in these cases, the Tₘ₁ is the defining characteristic for which the polymer is selected for use in the present disclosure. Melting points (Tₘ₁) are measured by methods and instruments that are well known in the polymer arts.

Other polymers, such as amorphous polymers, do not possess a Tₘ₁, but instead can be characterized by a glass transition temperature T_{g1} that is measured by methods and instruments well known in the polymer arts.

In some embodiments, each polymer in the structured cold-sintered ceramic composite is chosen such that its Tₘ₁, if the polymer is crystalline or semi-crystalline, or its T_{g1}, if the polymer is amorphous, is greater than T₁. In other embodiments, Tₘ₁ or T_{g1} is less than the temperature (T₁) that is 200° C. above the boiling point of the solvent or solvent mixture (as determined at 1 bar) that is used in the cold sintering process described herein. Thus, according to one illustrative embodiment, the solvent is water, which has a boiling point of 100° C. at one bar, and so the polymer should have a Tₘ₁ or T_{g1} that is no greater than 300° C. In other embodiments, T₁ is between about 70° C. to about 250° C., or between about 100° C. to about 200° C. Although water can be a solvent in these illustrative embodiments because T₁ is no greater than 200° C. above the boiling point of water at one bar, various other solvents and solvent mixtures satisfy these basic requirements.

In other embodiments, however, a suitable polymer is selected primarily on the basis of the polymer being a branched polymer and it can, in some embodiments, additionally be selected according to Tₘ₁ or T_{g1} as discussed above. A branched polymer, as is understood in the polymer arts, is a polymer that is not entirely linear, i.e., the backbone of the polymer contains at least one branch, and in some embodiments the degree of branching is substantial. Without wishing to be bound by any particular theory, the inventors believe, according to various embodiments, that branched polymers shear under the pressures employed during the cold sintering process, enabling a given branched polymer to undergo a higher flow than its linear counterpart, such that only the branched polymer is suitable for making a structured cold-sintered ceramic composite as described herein.

Examples of polymer architectures contemplated for use in the inventive processes include linear and branched polymers, copolymers such as random copolymers and block copolymers, and cross-linked polymers. Also contemplated are polymer blends, and blends of cross-linked polymers with non-crosslinked polymers.

Exemplary classes of polymers include polyimides, polyamides, polyesters, polyurethanes, polysulfones, polyketones, polyformals, polycarbonates, and polyethers. Additional classes and specific polymers include acrylonitrile butadiene styrene (ABS) polymer, an acrylic polymer, a celluloid polymer, a cellulose acetate polymer, a cycloolefin copolymer (COC), an ethylene-vinyl acetate (EVA) polymer, an ethylene vinyl alcohol (EVOH) polymer, a fluoroplastic, an acrylic/PVC alloy, a liquid crystal polymer (LCP), a polyacetal polymer (POM or acetal), a polyacrylate polymer, a polymethylmethacrylate polymer (PMMA), a polyacrylonitrile polymer (PAN or acrylonitrile), a polyamide polymer (PA, such as nylon), a polyamide-imide polymer (PAI), a polyaryletherketone polymer (PAEK), a polybutadiene polymer (PBD), a polybutylene polymer (PB), a polybutylene terephthalate polymer (PBT), a polycaprolactone polymer (PCL), a polychlorotrifluoroethylene polymer (PCTFE), a polytetrafluoroethylene polymer (PTFE), a polyethylene terephthalate polymer (PET), a polycyclohexylene dimethylene terephthalate polymer (PCT), a polycarbonate polymer (PC), poly(1,4-cyclohexylidene cyclohexane-1,4-dicarboxylate) (PCCD), a polyhydroxyalkanoate polymer (PHA), a polyketone polymer (PK), a polyester polymer, a polyethylene polymer (PE), a polyetheretherketone polymer (PEEK), a polyetherketoneketone polymer (PEKK), a polyetherketone polymer (PEK), a polyetherimide polymer (PEI), a polyethersulfone polymer (PES), a polyethylenechlorinate polymer (PEC), a polyimide polymer (PI), a polylactic acid polymer (PLA), a polymethylpentene polymer (PMP), a polyphenylene oxide polymer (PPO), a polyphenylene sulfide polymer (PPS), a polyphthalamide polymer (PPA), a polypropylene polymer, a polystyrene polymer (PS), a polysulfone polymer (PSU), a polytrimethylene terephthalate polymer (PTT), a polyurethane polymer (PU), a polyvinyl acetate polymer (PVA), a polyvinyl chloride polymer (PVC), a polyvinylidene chloride polymer (PVDC), a polyamideimide polymer (PAI), a polyarylate polymer, a polyoxymethylene polymer (POM), a styrene-acrylonitrile polymer (SAN), polyethylene terephthalate (PET), polyetherimide (PEI), poly(p-phenylene oxide) (PPO), polyamide(PA), polyphenylene sulfide (PPS), polyethylene (PE) (e.g., ultra high molecular weight polyethylene (UHMWPE), ultra low molecular weight polyethylene (ULMWPE), high molecular weight polyethylene (HMWPE), high density polyethylene (HDPE), high density cross-linked polyethylene (HDXLPE), cross-linked polyethylene (PEX or XLPE), medium density polyethylene (MDPE), low density polyethylene (LDPE), linear low density polyethylene (LLDPE) and very low density polyethylene (VLDPE)), polypropylene (PP), and combinations thereof.

Additional polymers include polyacetylenes, polypyrroles, polyanilines, poly(p-phenylene vinylene), poly(3-alkylthiophenes), polyacrylonitrile, poly(vinylidene fluoride), polyesters (such as polyalkylene terephthalates), polyacrylamides, polytetrafluoroethylene, polytrifluorochloroethylene, polytrifluorochloroethylene, perfluoroalkoxy alkanes, polyaryl ether ketones, polyarylene sulfones, polyaryl ether sulfones, polyarylene sulfides, polyimides, polyamidoimides, polyesterimides, polyhydantoins, polycycloenes, liquid crystalline polymers, polyarylensulfides, polyoxadiazobenzimidazoles, polyimidazopyrolones, polypyrones, polyorganosiloxanes (such as polydimethylsiloxane), polyamides (such as nylons), acrylics, sulfonated polymers, co-polymers thereof, and blends thereof.

Other useful polymers or oligomers are ionomeric oligomers or polymers (“ionomers”). A key feature of ionomers resides in a relatively modest concentration of acid or ionic groups that are bound to an oligomer/polymer backbone or end groups, and that confer substantial changes in the physical, mechanical, optical, dielectric, and dynamic properties to a polymer and, hence, to the cold-sintered ceramic polymer composite. For example, polymers that bear acid functional groups can undergo interchain and physical crosslinks via hydrogen bonding between acid groups. Illustrative oligomers include sulfonated oligomers. In addition, fatty acids or tetra-alkyl ammonium salts can be introduced by the inventive processes in order to promote additional ionic interactions.

### Inorganic Compound

In accordance with the inventive process, a plurality of open cells of the open cell substrate disclosed herein is filled with at least one inorganic compound that is in the form of particles having a number average particle size of less than about 30 μm. Useful inorganic compounds include, without limitation, metal oxides, metal carbonates, metal sulfates, metal sulfides, metal selenides, metal tellurides, metal arsenides, metal alkoxides, metal carbides, metal nitrides, metal halides (e.g., fluorides, bromides, chlorides, and iodides), clays, ceramics glasses, metals, and combinations thereof. Specific examples of inorganic compounds include MoO₃, WO₃, V₂O₃, ZnO, Al₂O₃, Bi₂O₃, CsBr, SiC, Li₂CO₃, CsSO₄, Li₂MoO₄, Na₂Mo₂O₇, K₂Mo₂O₇, ZnMoO₄, Gd₂(MoO₄)₃, Li₂WO₄, Na₂WO₄, LiVO₃, BiVO₄, AgVO₃, Na₂ZrO₃, LiFePO₄, and KH₂PO₄, ZrO₂.

In some embodiments, the inventive process uses mixtures of inorganic compounds that, upon sintering, react with each other to provide a sintered ceramic material (solid state reactive sintering). One advantage of this approach is the reliance upon comparatively inexpensive inorganic compound starting materials. Additional advantages of a solid-state reactive sintering (SSRS) method includes the simplified fabrication process for proton conducting ceramics by combining phase formation, densification, and grain growth into one sintering step. See S. Nikodemski et al., Solid State Ionics 253 (2013) 201-210. One example of reactive inorganic compounds relates to the sintering of Cu₂S and In₂S₃ to yield stoichiometric CuInS₂. See T. Miyauchi et al., Japanese Journal of Applied Physics, vol. 27, Part 2, No. 7, L1178. Another example is the addition of NiO to Y₂O₃, ZrO₂, and BaCO₃ to yield BaY₂NiO₅ upon sintering. See J. Tong, J. Mater. Chem. 20 (2010) 6333-6341.

The inorganic compound is present in the form of particles, such as a fine powder. Any conventional method for producing a particulate form of the inorganic compound is suitable. For example, the particles can result from various milling processes, such as ball milling, attrition milling, vibratory milling, and jet milling.

The resultant particle size, i.e., diameter, of the inorganic compound is about 100 μm or less, based on the particle number average. In various embodiments, the average number particle size is less than about 90 μm, less than about 80 μm, less than about 70 μm, less than about 60 μm, less than about 50 μm, less than about 40 μm, less than about 30 μm, less than about 20 μm, or less than about 10 μm. Any suitable method can be used to measure particle size and distribution, such as laser scattering. In illustrative embodiments, at least 80%, at least 85%, at least 90%, or at least 95% of the particles by number have a size that is less than the stated number average particle size.

According to some embodiments of the disclosure, the inorganic compound is combined with a solvent to obtain a mixture. In other embodiments, the inorganic compound is combined with a solvent, and at least one monomer, reactive oligomer, or combination thereof to obtain a mixture. In these embodiments, the inorganic compound is present in about 50 to about 99 wt %, based upon the total weight of the filled-cell substrate. Exemplary weight percentages of the inorganic compound in the mixture are at least 50%, at least 55%, at least 60%, at least 65%, at least 70%, at least 75%, at least 80%, at least 85%, and at least 90%.

### Solvents

The process of the disclosure employs at least one solvent in which the inorganic compound has at least partial solubility. Useful solvents include water, an alcohol such as a C₁₋₆-alkyl alcohol, an ester, a ketone, dipolar aprotic solvents (e.g., dimethylsulfoxide (DMSO), N-methyl-2-pyrrolidone (NMP), and dimethylformamide (DMF)), and combinations thereof. In some embodiments, only a single solvent is used. In other embodiments, mixtures of two or more solvents are used.

Still other embodiments provide for aqueous solvent systems to which one or more other components are added for adjusting pH. The components include inorganic and organic acids, and organic and inorganic bases.

Examples of inorganic acids include sulfurous acid, sulfuric acid, hyposulfurous acid, persulfuric acid, pyrosulfuric acid, disulfurous acid, dithionous acid, tetrathionic acid, thiosulfurous acid, hydrosulfuric acid, peroxydisulfuric acid, perchloric acid, hydrochloric acid, hypochlorous acid, chlorous acid, chloric acid, hyponitrous acid, nitrous acid, nitric acid, pernitric acid, carbonous acid, carbonic acid, hypocarbonous acid, percarbonic acid, oxalic acid, acetic acid, phosphoric acid, phosphorous acid, hypophosphous acid, perphosphoric acid, hypophosphoric acid, pyrophosphoric acid, hydrophosphoric acid, hydrobromic acid, bromous acid, bromic acid, hypobromous acid, hypoiodous acid, iodous acid, iodic acid, periodic acid, hydroiodic acid, fluorous acid, fluoric acid, hypofluorous acid, perfluoric acid, hydrofluoric acid, chromic acid, chromous acid, hypochromous acid, perchromic acid, hydroselenic acid, selenic acid, selenous acid, hydronitric acid, boric acid, molybdic acid, perxenic acid, silicofluoric acid, telluric acid, tellurous acid, tungstic acid, xenic acid, citric acid, formic acid, pyroantimonic acid, permanganic acid, manganic acid, antimonic acid, antimonous acid, silicic acid, titanic acid, arsenic acid, pertechnetic acid, hydroarsenic acid, dichromic acid, tetraboric acid, metastannic acid, hypooxalous acid, ferricyanic acid, cyanic acid, silicous acid, hydrocyanic acid, thiocyanic acid, uranic acid, and diuranic acid.

Examples of organic acids include malonic acid, citric acid, tartartic acid, glutamic acid, phthalic acid, azelaic acid, barbituric acid, benzilic acid, cinnamic acid, fumaric acid, glutaric acid, gluconic acid, hexanoic acid, lactic acid, malic acid, oleic acid, folic acid, propiolic acid, propionic acid, rosolic acid, stearic acid, tannic acid, trifluoroacetic acid, uric acid, ascorbic acid, gallic acid, acetylsalicylic acid, acetic acid, and sulfonic acids, such as p-toluene sulfonic acid.

Examples of inorganic bases include aluminum hydroxide, ammonium hydroxide, arsenic hydroxide, barium hydroxide, beryllium hydroxide, bismuth(iii) hydroxide, boron hydroxide, cadmium hydroxide, calcium hydroxide, cerium(iii) hydroxide, cesium hydroxide, chromium(ii) hydroxide, chromium(iii) hydroxide, chromium(v) hydroxide, chromium(vi) hydroxide, cobalt(ii) hydroxide, cobalt(iii) hydroxide, copper(i) hydroxide, copper(ii) hydroxide, gallium(ii) hydroxide, gallium(iii) hydroxide, gold(i) hydroxide, gold(iii) hydroxide, indium(i) hydroxide, indium(ii) hydroxide, indium(iii) hydroxide, iridium(iii) hydroxide, iron(ii) hydroxide, iron(iii) hydroxide, lanthanum hydroxide, lead(ii) hydroxide, lead(iv) hydroxide, lithium hydroxide, magnesium hydroxide, manganese(ii) hydroxide, manganese(vii) hydroxide, mercury(i) hydroxide, mercury(ii) hydroxide, molybdenum hydroxide, neodymium hydroxide, nickel oxo-hydroxide, nickel(ii) hydroxide, nickel(iii) hydroxide, niobium hydroxide, osmium(iv) hydroxide, palladium(ii) hydroxide, palladium(iv) hydroxide, platinum(ii) hydroxide, platinum(iv) hydroxide, plutonium(iv) hydroxide, potassium hydroxide, radium hydroxide, rubidium hydroxide, ruthenium(iii) hydroxide, scandium hydroxide, silicon hydroxide, silver hydroxide, sodium hydroxide, strontium hydroxide, tantalum(v) hydroxide, technetium(ii) hydroxide, tetramethylammonium hydroxide, thallium(i) hydroxide, thallium(iii) hydroxide, thorium hydroxide, tin(ii) hydroxide, tin(iv) hydroxide, titanium(ii) hydroxide, titanium(iii) hydroxide, titanium(iv) hydroxide, tungsten(ii) hydroxide, uranyl hydroxide, vanadium(ii) hydroxide, vanadium(iii) hydroxide, vanadium(v) hydroxide, ytterbium hydroxide, yttrium hydroxide, zinc hydroxide, and zirconium hydroxide.

Organic bases typically are nitrogenous, as they can accept protons in aqueous media. Exemplary organic bases include primary, secondary, and tertiary (C₁₋₁₀)-alkylamines, such as methyl amine, trimethylamine, and the like. Additional examples are (C₆₋₁₀)-arylamines and (C₁₋₁₀)-alkyl-(C₆₋₁₀)-aryl-amines. Other organic bases incorporate nitrogen into cyclic structures, such as in mono- and bicyclic heterocyclic and heteroaryl compounds. These include, for instance, pyridine, imidazole, benzimidazole, histidine, and phosphazenes.

In some processes described herein, the inorganic compound is combined with the solvent to obtain a mixture. According to various embodiments, the solvent is present in about 40% or less by weight, based upon the total weight of the filled-cell substrate. Alternatively, the weight percentage of the solvent in the mixture is 35% or less, 30% or less, 25% or less, 20% or less, 15% or less, 10% or less, 5% or less, 3% or less, or 1% or less. In an exemplary embodiment, the solvent comprises at least 50% water by weight, based upon the total weight of the solvent.

### Polymer With Inorganic Compound

In some embodiments, the particular inorganic compound for filling the open cells exists in combination with at least one polymer P_{2.} In some embodiments, polymer P₂ has a melting point Tₘ₂, if the polymer is crystalline or semi-crystalline, or a glass transition temperature T_{g2}, if the polymer is amorphous, that is greater than T₁. In other embodiments, Tₘ₂ or T_{g2} is less than T₁. The polymer P₂ need not be necessarily the same as the polymer P₁ in embodiments wherein the substrate is comprised of P₁. Thus, for instance, Tₘ₂ or T_{g2} is lower than Tₘ₁ or T_{g1}. Suitable choices for polymers P₂ are the same as those described above for P₁. In other embodiments, P₁ and P₂ are the same.

In some embodiments providing for the presence of polymers P₁ and P₂, the polymers are selected independently from the group consisting of polyacetylenes, polypyrroles, polyanilines, poly(p-phenylene vinylene), poly(3-alkylthiophenes), polyacrylonitrile, poly(vinylidene fluoride), polyesters, polyacrylamides, polytetrafluoroethylene, polytrifluorochloroethylene, polytrifluorochloroethylene, perfluoroalkoxy alkanes, polyaryl ether ketones, polyarylene sulfones, polyaryl ether sulfones, polyarylene sulfides, polyimides, polyamidoimides, polyesterimides, polyhydantoins, polycycloenes, liquid crystalline polymers, polyarylensulfides, polyoxadiazobenzimidazoles, polyimidazopyrolones, polypyrones, polyorganosiloxanes, polyamides, acrylics, polycarbonate, polyetherether ketone, polyetherimide, polyethersulfone, polyethylene, polypropylene, polystyrene, polytetrafluoroethylene, polyurethanes, polyvinyl chloride, polyvinylidene difluoride, and sulfonated tetrafluoroethylene (Nafion), co-polymers thereof, and blends thereof.

### Additional Components

Various embodiments of the inventive processes contemplate the introduction of one or more additional materials to the inorganic compound for cold sintering. Any combination of these materials is possible to ease manufacture of, and/or tailor the composition and properties of, the cold-sintered ceramic composite. In general, any of the additives described herein are present in an amount of about 0.001 wt % to about 50 wt %, about 0.01 wt % to about 30 wt %, about 1 to about 5 wt %, or about 0.001 wt % or less, or about 0.01 wt %, 0.1, 1, 2, 3, 4, 5, 10, 15, 20, 25, 30, 35, 40, 45 wt %, or about 50 wt % or more, based upon the total weight of the filled-cell substrate.

### Supramolecular Structures

For instance, some embodiments provide for the addition of supramolecular structures, which are generally characterized by an assembly of substructures that are held together by weak interactions, such as non-covalent bonds. The interactions can weaken at temperatures that are employed for cold-sintering, thereby liberating substructure molecules that can flow through or into newly-created pores of the particulate inorganic compound or cold-sintered ceramic. Upon cooling, the substructure molecules can reassemble into supramolecular structures that are embedded into the cold-sintered ceramic. Typical compounds suitable for this purpose are hydrogen bonded molecules, which can possess, for instance mono, bi-, tri-, or quadruple hydrogen bonds. Other structures exploit host-guest interactions and in this way create supramolecular (polymeric) structures.

Examples of supramolecular structures include macrocycles such as cyclodextrins, calixarenes, cucurbiturils, and crown ethers (host-guest interaction based on weak interactions); amide or carboxylic acid dimers, trimer or tetramers such as 2-ureido-4[1H]-pyrimidinones (via hydrogen bonding), bipyridines or tripyridines (via complexation with metals), and various aromatic molecules (via pi-pi interaction).

### Sol-Gels

Other embodiments provide for the addition of a sol-gel to the inorganic compound. The sol-gel process consists of a series of hydrolysis and condensation reactions of a metal alkoxide; in some instances, alkoxysilanes are also used. Hydrolysis is initiated by the addition of water to the alkoxide or silane solution under acidic, neutral, or basic conditions. Thus, by adding a small amount of water to a metal alkoxide, a polymeric nanocomposite can be obtained. Examples of compounds that are useful for making sol-gels include silicon alkoxides such as tetraalkyl orthosilicates (e.g., tetraethyl orthosilicate), silsesquioxanes, and phenyltriethoxysilanes.

### Fillers

According to some embodiments, the inorganic compound can be mixed with one or more fillers. The filler is present in about 0.001 wt % to about 50 wt % of the composite, or about 0.01 wt % to about 30 wt %, or about 0.001 wt % or less, or about 0.01 wt %, 0.1, 1, 2, 3, 4, 5, 10, 15, 20, 25, 30, 35, 40, 45 wt %, or about 50 wt % or more. The filler can be homogeneously distributed with the inorganic compound. The filler can be fibrous or particulate. The filler can be aluminum silicate (mullite), synthetic calcium silicate, zirconium silicate, fused silica, crystalline silica graphite, natural silica sand, or the like; boron powders such as boron-nitride powder, boron-silicate powders, or the like; oxides such as TiO₂, aluminum oxide, magnesium oxide, or the like; calcium sulfate (as its anhydride, dehydrate or trihydrate); calcium carbonates such as chalk, limestone, marble, synthetic precipitated calcium carbonates, or the like; talc, including fibrous, modular, needle shaped, lamellar talc, or the like; wollastonite; surface-treated wollastonite; glass spheres such as hollow and solid glass spheres, silicate spheres, cenospheres, aluminosilicate (armospheres), or the like; kaolin, including hard kaolin, soft kaolin, calcined kaolin, kaolin including various coatings known in the art to facilitate compatibility with the polymeric matrix resin, or the like; single crystal fibers or “whiskers” such as silicon carbide, alumina, boron carbide, iron, nickel, copper, or the like; fibers (including continuous and chopped fibers) such as asbestos, carbon fibers, glass fibers; sulfides such as molybdenum sulfide, zinc sulfide, or the like; barium compounds such as barium titanate, barium ferrite, barium sulfate, heavy spar, or the like; metals and metal oxides such as particulate or fibrous aluminum, bronze, zinc, copper and nickel, or the like; flaked fillers such as glass flakes, flaked silicon carbide, aluminum diboride, aluminum flakes, steel flakes or the like; fibrous fillers, for example short inorganic fibers such as those derived from blends including at least one of aluminum silicates, aluminum oxides, magnesium oxides, and calcium sulfate hemihydrate or the like; natural fillers and reinforcements, such as wood flour obtained by pulverizing wood, fibrous products such as kenaf, cellulose, cotton, sisal, jute, flax, starch, corn flour, lignin, ramie, rattan, agave, bamboo, hemp, ground nut shells, corn, coconut (coir), rice grain husks or the like; organic fillers such as polytetrafluoroethylene, reinforcing organic fibrous fillers formed from organic polymers capable of forming fibers such as poly(ether ketone), polyimide, polybenzoxazole, poly(phenylene sulfide), polyesters, polyethylene, aromatic polyamides, aromatic polyimides, polyetherimides, polytetrafluoroethylene, acrylic resins, poly(vinyl alcohol) or the like; as well as fillers such as mica, clay, feldspar, flue dust, fillite, quartz, quartzite, perlite, Tripoli, diatomaceous earth, carbon black, or the like, or combinations including at least one of the foregoing fillers. The filler can be talc, kenaf fiber, or combinations thereof. The filler can be coated with a layer of metallic material to facilitate conductivity, or surface treated with silanes, siloxanes, or a combination of silanes and siloxanes to improve adhesion and dispersion within the composite. The filler can be selected from carbon fibers, mineral fillers, and combinations thereof. The filler can be selected from mica, talc, clay, wollastonite, zinc sulfide, zinc oxide, carbon fibers, glass fibers, ceramic-coated graphite, titanium dioxide, or combinations thereof.

### Structured Cold-sintered Ceramic Composite

In accordance with the general provisions of the disclosure, a plurality of open cells of the open cell substrate are filled with at least one inorganic compound and solvent, as described herein, to give a filled-cell substrate. According to some embodiments, at least 60% of the open cells are filled. Other embodiments provide for at least 70%, at least 80%, at least 90%, and at least 95% of the open cells to be filled. In an exemplary embodiment, 100% of the open cells are filled.

The filled-cell substrate is then subjected to a pressure of no more than about 5000 MPa and a temperature (T₁) that is no greater than 200° C. above the boiling point of the solvent (as determined at 1 bar) to obtain a single layer structured cold-sintered ceramic composite. Depending upon choice of substrate non-ceramic material, the substrate can maintain its microarchitecture through the cold sintering process. In some embodiments, however, such as those in which the substrate is comprised of a polymer, the substrate can melt, fuse, or otherwise become structurally unified, in whole or in part, with the inorganic compound as it is cold-sintered. The resultant single layer structured cold-sintered ceramic composite thus maintains the shape and thickness of the open- or filled-cell substrate.

### Cold-sintered Multi-layer Ceramic Composite

The single layer structured cold-sintered ceramic composites described herein, while useful alone in some embodiments, can be layered together to build a cold-sintered multi-layer ceramic composite. The multi-layer composite is highly configurable because of the ease with which its dimensions, composition, strength, and other characteristics can be tuned by precise selection of the single layer ceramic composites as described herein.

### Process I

One process for making the multi-layer composite, according to one embodiment, entails the sequential filling of a plurality of open cells of an open cell substrate (step (a)) and subjecting the resultant filled-cell substrate to a pressure and temperature as described herein (step (b)) a multitude of times to obtain a corresponding multitude of single layer structured cold-sintered ceramic composites. The process further comprises layering the single layer structured cold-sintered ceramic composites to obtain a cold-sintered multi-layer ceramic composite (step (c)).

The multi-layer ceramic composite produced by this process, in one embodiment, is further subjected to a traditional sintering step. The additional sintering promotes adhesion of the single layer ceramic composites to each other and further promotes structural integrity of the multi-layer ceramic composite.

Alternatively, according to another embodiment, step (c) described above further comprises depositing a bonding layer of a curable adhesive, a curable epoxy, a polymer P₃, or a combination thereof between adjacent single layer structured cold-sintered ceramic composites. Polymer P₃ has a melting point (Tₘ₃), if the polymer is crystalline or semi-crystalline, or a glass transition temperature (T_{g3}), if the polymer is amorphous. In this embodiment, the process further comprises (d) subjecting the product of step (c) to a pressure of no more than about 5000 MPa and/or a temperature (T₂) that is above Tₘ₃ or T_{g3}. In this manner, bonding layers of curable adhesive, curable epoxy, polymer P₃, or combination thereof adhere the individual single layer ceramic composites to each other.

The polymer P₃ is chosen from any of the polymers described herein. Many curable adhesives and curable epoxies suitable for this process are known to the skilled person. Illustrative curable adhesives are heat-cured adhesives, such as phenol-formaldehyde adhesives (i.e., phenolic resins) and heat-cured urethanes. Heat curable epoxies include single and double component epoxies, such as epoxy resin/hardener combinations. Each bonding layer is a thickness of about 0.1 μm to about 1000 μm.

### Process II

According to other embodiments, the multi-layer ceramic composite is produced by an alternative order of steps. More specifically, filling step (a) is performed sequentially a multitude of times to obtain a corresponding multitude of single layer filled-cell substrates. The process further comprises the step of (b1) layering the multitude of single layer filled-cell substrates to obtain a multi-layer filled-cell substrate. Then the subjecting step (b) is performed on the multi-layer filled-cell substrate to obtain a cold-sintered multi-layer composite. The cold-sintering conditions in step (b) alone are sufficient to fasten the single layer filled-cell substrates to each other. In some embodiments, however, the process further comprises sintering the cold-sintered multi-layer composite. Instead of a sintering step, the process in some embodiments comprises annealing the cold-sintered multi-layer composite. The annealing step is performed at a temperature in the range of about 100° C. to about 400° C. Annealing can occur at a constant temperature or, in accordance with some embodiments, at a ramped or pre-programmed temperature profile within the range disclosed above.

The structure of a single layer structured cold-sintered ceramic composite can affect structure and properties of the multi-layer ceramic composite. For instance, in combination with any of the processes for making the multi-layer ceramic composite, one embodiment provides for each single layer structured cold-sintered ceramic composite to have the same shape of open cell in the substrate.

Alternatively, a number percentage of the single layer structured cold-sintered ceramic composites have open cell shapes that are different from the shape of cells in the remaining single layer structured cold-sintered ceramic composites. In various embodiments, the percentage ranges from about 1% to about 90%, about 5% to about 80%, and about 10% to about 50%. Thus, in an illustrative multi-layer ceramic composite, some single layer structured cold-sintered ceramic composites have a honeycomb pattern of open cells, and the remaining single layer structured cold-sintered ceramic composites have rectangular open cells. Additional examples include multi-layer ceramic composites wherein the single layer structured cold-sintered ceramic composites therein constitute three or more different cell shapes.

In accordance with other embodiments, the orientations of single layer structured cold-sintered ceramic composites are varied with respect to each other as the single layers are layered on each other. The orientations can vary widely in design from purely random, block (i.e., A-B-A-B-, A-A-B-B-, etc.), and random block patterns. For instance, one orientation (A) aligns rectangular cells of some single layer structured cold-sintered ceramic composites along one axis (A-axis), while another orientation (B) aligns rectangular cells of other single layer structured cold-sintered ceramic composites along a different axis (B-axis), such as 45° or 90° to the A-axis. All combinations of numbers of open cell shapes and single-layer ceramic composite orientations are contemplated. It is believed without limitation by any particular theory that variance in cell shapes, single layer orientations, or both significantly strengthen the multi-layer ceramic composite and prevent or limit crack propagation through it.

### Additional Process Steps

The final physical form and properties of the single or multi-layer cold-sintered ceramic composite can be further tailored by performing additional steps that occur before and/or after the cold-sintering step. For example, the inventive process in various embodiments includes one or more steps that include injection molding, autoclaving, calendering, dry pressing, tape casting, and extrusion. The steps can be performed on a filled-cell substrate, for instance, so as to impose physical forms or geometry that is retained after the cold-sintering step.

Alternatively, or in addition, a variety of post-curing or finishing steps are introduced. These include, for instance, annealing and machining. An annealing step is introduced, in some embodiments, where greater physical strength or resistance to cracking is desired in the single or multi-layer cold-sintered ceramic composite. In addition, for some polymers or polymer combinations, the cold-sintering step, while sufficient to sinter the ceramic, does not provide enough heat to ensure complete flow of the polymer(s) into the ceramic voids. Hence, an annealing step can provide the heat for a time sufficient for complete flow to be achieved, and thereby ensure improved break-down strength, toughness, and tribological properties, for instance, in comparison to a cold-sintered ceramic composite that did not undergo an annealing step.

Alternatively, the cold-sintered ceramic composite can be subjected to optionally pre-programmed temperature and/or pressure ramps, holds, or cycles, wherein the temperature or pressure or both are increased or decreased, possibly multiple times.

The cold-sintered ceramic polymer composite also can be machined using conventional techniques known in the art. A machining step can be performed to yield finished parts. For instance, a pre-sintering step of dry-pressing can yield an overall shape to single-layer cold-sintered ceramic composite, while a post-sintering step of machining on a resultant multi-layer cold-sintered ceramic composite can add detail and precise features.

### EXAMPLES

Definitions of materials and terms used throughout the following examples are as follows:
Die—a stainless steel pellet press die set, with die size of either 13 mm or 35 mm internal diameter (Chemplex Industries Inc.).
Press—a manual hydraulic press 15-ton capacity (Specac Ltd.).
ZnO—Zinc Oxide having a bimodal distribution of 500 nm and 75 nm with a mass ratio of 37:1.
Ultem: Ultem 1010 is a commercially available polyetherimide (SABIC) having an average particle size Dv50=15.4 μm; Molecular weight=51000 g/mol; Molecular number=21000 g/mol; and Tg=218° C.).
Open cell structures—films (e.g. a 10 μm thick sheet of the polyetherimide Ultem 1000 or 1010) with or without open cells (circles, ellipse, rectangle etc.). Open cell structures also refer to additively manufactured 3D part (e.g. a fused deposition modeling printed part, printed using ULTEM 1010 resin filament). Other methods for making open cell structures can include milling, selective laser sintering, injection molding, inject printing, and nanolithography.

### General Sample Procedure

All samples described in detail below were prepared by mixing ZnO or a specified mixture of ZnO and Ultem as a dry powder with a solution of 1.8 M zinc acetate (pH of about 6) in a ratio of 66 μL solution per gram of powder. The resulting composition was mixed with a mortar and pestle until homogenous. The desired open cell structures were prepared and placed into the die. A total of 3 g of composition was used for each 13 mm pellet, and 18 g was used for each 35 mm pellet. The dies were pressurized to 150 MPa for the 35 mm die and 295 MPa for the 13 mm die. The temperature was applied to the outside of the die using a heater band jacket. The external temperature was ramped to 180° C. at a rate of 10° C./min The internal temperature was monitored using a thermocouple. After the internal temperature reached 90° C., a 45 minute timer was set. During this time the pressure of the system begins to drop. The pressure was maintained at the desired pressure (150 MPa or 295 MPa) for 5 minutes, after which time the pressure was allowed to decrease by itself. After the 45 minute period, the external heater band was removed and the samples were allowed to cool under any residual pressure to room temperature. The samples were then removed from the die and characterized. Density was used as the metric to determine how well the ceramic component was sintered.

### Density Measurement

Geometric (volume) method: The diameter (D) and thickness (t) of the cylindrical samples were measured using a digital caliper. The volume of a cylinder can be calculated from the formula V=π(D/2)²×t. The mass of the cylindrical sample was measured with an analytical balance. The relative density was determined by dividing the mass by the volume.

The volume method is comparable to Archimedes method for simple geometries, such as cubes, cuboids and cylinders, in which it is relatively easy to measure sample volume. For samples with highly irregular geometry, however, accurately measuring the volume may be difficult, in which case the Archimedes method is preferred to measure density.

### Impact Testing

Selected samples were tested using a custom built small (table top) impact tester. The impact tester is comprised of a base on which a sample holder is mounted. Attached to the base is a vertical column, which has a linear rail and on which a carriage assembly is mounted. The carriage can move in the vertical direction. At the bottom of the carriage is a stainless steel dart (6.35 mm tip diameter). At the top of the carriage is a mass that can slide in the vertical direction along a vertical rod. The movement of the mass is assisted with a ball bearing between the weight and the rod.

In operation, a sample is mounted on a samples holder. A metal O-ring is placed between the sample and the holder. The dart is then slowly lowered on to the sample. The dart is placed approximately at the center of the sample. The calibrated mass (535 grams) is raised to 3 cm height and then dropped. If the sample does not break, the mass is raised to 3 cm height and dropped again. This operation is repeated 100 times or until the sample breaks, whichever occurs first. At the end of the experiment, the number of hits to failure is recorded and reported.

### Diametral Compression Test

In the diametral compression test method, a circular disk is compressed along its diameter by two flat metal plates. The compression along the diameter creates a maximum tensile stress perpendicular to the loading direction in the mid-plane of the specimen (see J. J. Swab et al., Int J Fract (2011) 172: 187-192). The fracture strength (σf) of the ceramic can be calculated by the formula:

$${σ}_{f} = \frac{2 P}{π Dt}$$

where P is the fracture load, D is the disk diameter and t is the disk thickness.

All tests were conducted on an ElectroPlus™ E3000 All-electric dynamic test instrument (Instron) with a 5000 N load cell at room temperature. The specimens were mounted between two flat metal plates and a small pre-load of 5 N was applied. Diametral compression tests were conducted under displacement control (0.5 mm/min), and time, compressive displacement and load data was captured at 250 Hz.

Prior to testing, all specimens were speckled using black spray paint. During diametral compression, sequential images of the speckled surface were captured with an INSTRON video extensometer AVE (Fujinon 35 mm) at a frequency of 50 Hz. After testing, all images were analyzed using the DIC replay software (Instron) to generate full-field strain maps. Transverse strain (ϵx) was analyzed in a 10 mm×20 mm region in the mid-plane of each specimen and transverse strain (ϵx) was calculated. The fracture stress (σf) and strain (ϵf) were calculated at the maximum load and maximum displacement. Toughness was calculated by measuring the area under the stress versus strain curve.

### SAMPLE PREPARATION

### Example 1A: ZnO Sample

18 g of ZnO powder was added to a mortar, to which 66 μL/g of 1.8 M Zinc Acetate was then added. The resultant mixture was then ground to a powder-like consistency using a pestle. The mixture was added to a stainless steel die (35 mm) and pressed into a ceramic pellet at 150 MPa and 180° C. for 45 min.

### Example 2A: ZnO/Polyetherimide Composites

Separate quantities of ZnO powder were mixed with quantities of 10, 20 and 40 vol %, respectively, of polyetherimide Ultem™ 1010 resin (average particle size Dv50=15.4 μm; Molecular weight=51000 g/mol; Molecular number=21000 g/mol; Tg=218° C.). To make ZnO with 40% ULTEM, 0.39 grams of ULTEM powder was mixed with 2.61 grams of ZnO. Each mixture was added to a mortar, to which 66 μL/g of 1.8 M Zinc Acetate was then added. The resultant mixture was then ground to a powder-like consistency using a pestle. Each mixture was added to a stainless steel die (13 mm) and pressed into a dense pellet at 295 MPa and 180° C. temperature for 45 min.

### Example 3A: Multi-Layered Ceramic Polymer Composites

18 g of ZnO powder was added to a mortar, to which 66 μL/g of 1.8 M Zinc Acetate was added. The resultant mixture was then ground to a powder-like consistency using a pestle and divided into 5 equivalent parts. Four 35 mm circles were punched (using an arch punch) from Ultem film. The layered structure was made by pouring one part of ceramic precursor mixture into the stainless steel die, flattening it out, placing a circular Ultem film on top, and then pouring another part of ZnO precursor mixture and repeating this process in an alternating fashion. Once the layering was completed, the layered assembly was pressed into a multi-layered composite pellet at 150 MPa pressure and 180° C. temperature for 45 min.

### Example 4A: Multi-Layered Ceramic Polymer Composites with Adhesive Layers

18 g of ZnO powder was added to a mortar, to which 66 μL/g of 1.8 M Zinc Acetate was then added. The resultant mixture was then ground to a powder-like consistency using a pestle and divided into 6 equivalent parts. Three 35 mm circles were punched (using an arch punch) from Ultem film. The layered structure was made by sequential pouring ceramic into the die, flattening it out, placing a Ultem circle on top, and then pouring on a quantity of ZnO precursor powder. The layered assembly was pressed into a composite pellet at 150 MPa pressure and 180° C. temperature for 45 min Two more composite pellets were made using the same process.

The three composite pellets were combined by inserting a first composite pellet in the die, adding an adhesive (Super 77 multipurpose adhesive, 3M) on the top surface and then inserting the second composite pellet in the die, adding another layer of adhesive on top and then inserting the third composite pellet. While the die is not necessary for this step, it ensures that the layers align properly.

### Example 5A: Multi-Layer Ceramic Polymer Composites

2.34 g of ULTEM was mixed with 15.66 g of ZnO powder in a mortar, to which 66 μL/g of 1.8 M Zinc Acetate was added. The resultant ceramic precursor mixture was then ground to a powder-like consistency using a pestle and divided into 5 equivalent parts. Four 35 mm circles were punched (using an arch punch) from Ultem film. A layered structure was made by sequentially pouring one part of the ceramic precursor mixture into the stainless steel die, flattening it out, and placing a circular Ultem film on top, and then pouring another part of ZnO precursor mixture and repeating this process in an alternating fashion. Once the layering was completed, the structure was pressed into a composite pellet at 150 MPa pressure and 180° C. temperature for 45 min.

### Example 6A: Multi-Layer Ceramic Polymer Composites with Adhesive Layers

2.34 g of ULTEM was mixed with 15.66 g of ZnO powder in a mortar, to which 66 μL/g of 1.8 M Zinc Acetate was added. The resultant precursor powder mixture was then ground to a powder-like consistency using a pestle and divided into 6 equivalent parts. Three 35 mm circles were punched (using an arch punch) from Ultem film. The layered structure was made by pouring ceramic into the die, flattening it out, and placing a Ultem circle on top and then pouring ZnO with precursor powder. The structure was pressed into a composite pellet at 150 MPa pressure and 180° C. temperature for 45 min.

Two more composite pellets were made using the same process. The three composite pellets were combined by inserting a first composite pellet in the die, adding an adhesive (Super 77 multipurpose adhesive, 3M) on the top surface and then inserting the second composite pellet in the die, adding another layer of adhesive on top and then inserting the third composite pellet. While the die is not necessary for this step, it ensures that the layers align properly.

### Example 7A: Multi-Layer Ceramic Polymer Composites (with Open Cells)

18 g of ZnO powder was added to a mortar, to which 66 μL/g of 1.8 M Zinc Acetate was added. The resultant mixture was then ground to a powder-like consistency using a pestle and divided into 5 equivalent parts. Four 35 mm circles were punched (using an arch punch) from Ultem film. Open cell structures were created by punching circular holes (0.5 mm or 4.7 mm) in the film. The smaller holes were created by poking the film with a pin. The larger holes were punched using a drill bit. The layered structure was made by pouring one part of ceramic precursor mixture into the stainless steel die, flattening it out, and placing a circular Ultem film with open cells on top and then pouring another part of ZnO precursor mixture and repeating this process in an alternating fashion. Once the layering was complete the structure was pressed into a composite pellet at 150 MPa pressure and 180° C. temperature for 45 min.

### Example 8A: Multi-Layer Ceramic Polymer Composites (with Open Cells) with Adhesive Layers

18 g of ZnO powder was added to a mortar, to which 66 μL/g of 1.8 M Zinc Acetate was added. The resultant mixture was then ground to a paste-like consistency using a pestle and divided into 6 equivalent parts. Three 35 mm circles were punched (using an arch punch) from Ultem film. Open cell structures were created by punching circular holes (0.5 mm or 4.7 mm) in the film. The smaller holes were created by poking the film with a pin. The larger holes were punched using a hole punch. The layered structure was made by pouring ceramic into the die, flattening it out, and placing a Ultem circle with open cells on top and then pouring ZnO with precursor powder. The structure is pressed into a composite pellet at 150 MPa pressure and 180° C. temperature for 45 min.

Two more composite pellets were made using the same process. The three composite pellets were combined by inserting a first composite pellet in the die, adding an adhesive (Super 77 multipurpose adhesive, 3M) on the top surface and then inserting the second composite pellet in the die, adding another layer of adhesive on top and then inserting the third composite pellet.

### Example 9A: Multi-Layer Ceramic Polymer Composites (with Open Cells)

2.34 g of ULTEM was mixed with 15.66 g of ZnO powder in a mortar, to which 66 μL/g of 1.8 M Zinc Acetate was added. The resultant mixture was then ground to a powder-like consistency using a pestle and divided into 5 equivalent parts. Four 35 mm circles were punched (using an arch punch) from Ultem film. Open cell structures were created by punching circular holes (0.5 mm or 4.7 mm) in the film The smaller holes were created by poking the film with a pin. The larger holes were punched using a drill bit. The layered structure was made by pouring one part of ceramic precursor mixture into the stainless steel die, flattening it out, and placing a circular Ultem film with open cells on top and then pouring another part of ZnO precursor mixture and repeating this process in an alternating fashion. Once the layering was complete the structure is pressed into a composite pellet at 150 MPa pressure and 180° C. temperature for 45 min.

### Example 10A: Multi-Layer Ceramic Polymer Composites (with Open Cells) with Adhesive Layers

2.34 g of ULTEM was mixed with 15.66 g of ZnO powder in a mortar, to which 66 μL/g of 1.8 M Zinc Acetate was added. The resultant mixture was then ground to a paste-like consistency using a pestle and divided into 6 equivalent parts. Three 35 mm circles were punched (using an arch punch) from Ultem film. Open cell structures were created by punching circular holes (0.5 mm or 4.7 mm) in the film. The smaller holes were created by poking the film with a pin. The larger holes were punched using a hole punch. The layered structure was made by pouring ceramic into the die, flattening it out, and placing an Ultem circle with open cells on top and then pouring ZnO with precursor powder. The structure was pressed into a composite pellet at 150 MPa pressure and 180° C. temperature for 45 min.

Two more composite pellets were made using the same process. The three composite pellets were combined by inserting a first composite pellet in the die, adding an adhesive (Super 77 multipurpose adhesive, 3M) on the top surface and then inserting the second composite pellet in the die, adding another layer of adhesive on top and then inserting the third composite pellet.

### Example 11A: Ceramic Polymer Composites (Open Cells)

3D printed open cell structures with square cells or hexagonal cells (35 mm diameter and 7 mm thickness) were inserted into a stainless steel die. 18 g of ZnO powder was added to a mortar, to which 66 μL/g of 1.8 M Zinc Acetate was added. The resultant mixture was then ground to a paste-like consistency using a pestle. The mixture was added to the stainless steel die and compacted. After packing the powder in as thoroughly as possible, any excess powder that remained above the top of the 3D-printed open cell structure layer was removed in order to make the top flush with the structure. The structure was then pressed into a ceramic pellet at 150 MPa and 180° C. temperature for 45 min.

### Example 12A: Ceramic Polymer Composites (Open Cells)

3D printed open cell structures with square cells or hexagonal cells (35 mm diameter and 7 mm thickness) were inserted into a stainless steel die. 2.34 g of ULTEM was mixed with 15.66 g of ZnO powder in a mortar, to which 66 μL/g of 1.8 M Zinc Acetate was added. The resultant mixture was then ground to a powder-like consistency using a pestle. The mixture was added to a stainless steel die and compacted. After packing the powder in as thoroughly as possible, any excess powder that remained above the top of the 3D-printed open cell structure was removed in order to make the top flush with the structure. The structure was then pressed into a ceramic pellet at 150 MPa and 180° C. temperature for 45 min.

Example 13A: Multi-Layered Ceramic And Multiple Polymer Composites

2.34 g of Polycarbonate was mixed with 15.66 g of ZnO powder in a mortar, to which 66 μL/g of 1.8 M Zinc Acetate was added. The resultant mixture was then ground to a powder-like consistency using a pestle and divided into 5 equivalent parts. Four 35 mm circles were punched (using an arch punch) from Ultem film. The layered structure was made by pouring one part of ceramic precursor mixture into the stainless steel die, flattening it out, and placing a circular Ultem film on top and then pouring another part of ZnO precursor mixture and repeating this process in an alternating fashion. Once the layering was completed the structure was pressed into a composite pellet at 150 MPa pressure and 180° C. temperature for 45 min.

### Example 14A: Multi-Layered Ceramic and Multiple Polymer Composites

2.34 g of Ultem powder was mixed with 15.66 g of ZnO powder in a mortar, to which 66 μL/g of 1.8 M Zinc Acetate was added. The resultant mixture was then ground to a powder-like consistency using a pestle and divided into 5 equivalent parts. Four 35 mm circles were punched (using an arch punch) from Ultem film. The layered structure was made by pouring one part of ceramic precursor mixture into the stainless steel die, flattening it out, and placing a circular Ultem film on top and then pouring another part of ZnO precursor mixture and repeating this process in an alternating fashion.

After flattening this structure, a 3D printed open cell structure with square cells (35 mm diameter and 7 mm thickness) was placed into the die. 2.34 g of Ultem powder was mixed with 15.66 g of ZnO powder in a mortar, to which 66 μL/g of 1.8 M Zinc Acetate was added. The resultant mixture was then ground to a powder-like consistency using a pestle. The 3D printed open cell structure was then filled with the powder mixture. After removing the excess powder from the top if the printed structure, it was pressed into a composite pellet at 150 MPa pressure and 180° C. temperature for 45 min.

### Properties

### Density

| | | Number | Polymer | | Relative |
|---|---|---|---|---|---|
| | | of | Volume | Density | Density |
| Example | Pattern | Pellets | (%) | (g/cm³) | (%) |
| Example 1A | | 6 | 0 | 5.21 | 92.92 |
| Example 2A a | | 6 | 10 | 4.84 | 93.52 |
| Example 2A b | | 6 | 20 | 4.47 | 94.43 |
| Example 2A b | | 6 | 20 | 4.47 | 94.43 |
| Example 2A c | | 6 | 40 | 3.82 | 98.68 |
| Example 3A | Layered | 2 | 0 | 5.45 | 97.30 |
| Example 4A | Layered | 1 | 0 | 4.87 | 82.03 |
| Example 5A | Layered | 2 | 40 | 3.80 | 98.60 |
| Example 6A | Layered | 1 | 40 | 3.45 | 89.10 |
| Example 7A | Layered | 5 | 0 | 5.41 | 96.40 |
| Example 8A | Layered | 1 | 0 | 5.15 | 84.79 |
| Example 9A | Layered | 1 | 40 | 3.87 | 101.0 |
| Example 10A | Layered | 1 | 40 | 3.87 | 92.30 |
| Example 11A a | 3D - Square | 2 | 0 | 2.21 | 41.35 |
| Example 11A b | 3D - Hexagonal | 2 | 0 | 2.48 | 60.32 |
| Example 12A a | 3D - Square | 2 | 40 | 2.01 | 62.05 |
| Example 12A b | 3D - Hexagonal | 2 | 40 | 2.14 | 55.27 |
| Example 13A | Layered | 1 | 40 | 3.12 | 80.53 |
| Example 14A | Layered + 3D | 1 | 40 | 3.11 | 55.56 |

### Impact Test Results

| | Number | | Polymer | |
|---|---|---|---|---|
| | of | Thickness | Volume | Number of |
| Example | Pellets | (mm) | (%) | Hits to Break |
| Example 1A | 1 | 4.04 | 0 | 1 |
| Example 2A a | | 4.26 | 10 | |
| Example 2A b | | 2.43 | 20 | |
| Example 2A c | | 5.86 | 40 | |
| Example 3A | 1 | 5.42 | 0 | 1 |
| Example 4A | 1 | 5.87 | 0 | 100* |
| Example 5A | 1 | 2.93 | 40 | 5 |
| Example 6A | 1 | 8.02 | 40 | 100* |
| Example 7A | 1 | 3.67 | 0 | 1 |
| Example 8A | 1 | 5.62 | 0 | 100* |
| Example 9A | 1 | 5.16 | 40 | 4 |
| Example 10A | 1 | 7.10 | 40 | 100* |
| Example 11A a | 1 | 3.41 | 0 | 26 |
| Example 11A b | 1 | 3.05 | 0 | 100* |
| Example 12A a | 1 | 3.53 | 0 | 100* |
| Example 12A b | 1 | 3.28 | 40 | 100* |
| Example 13A | 1 | 3.36 | 40 | 1 |
| Example 14A | | 8.71 | 40 | |

*no break.

Impact damage in layered samples without (examples 4A and 8A) and with ULTEM (examples 6A and 10A) demonstrated that the combination of ULTEM with ZnO improved the contact wear properties as observed by a smaller damage zone in example 6A and example 10A, as quantified in the table below.

### Impact Damage Results

| Example | Damage Diameter (μm) |
|---|---|
| 4A | 2531 |
| 6A | 858 |
| 8A | 5540 |
| 10A | 1036 |

In addition, impact damage in samples containing 3D-printed hexagonal grids demonstrate much greater impact resistance when the samples were prepared with ULTEM (example 12A b) as compared to those without ULTEM (example 11A b).

### Diametral Compression Results

| | Max | | Max | | | |
|---|---|---|---|---|---|---|
| | Stress | % | Strain | % | Toughness | % |
| Example | (MPa) | change | (%) | change | (MPa) | change |
| 1A | 13.72 | 0 | 0.05 | 0 | 0.24 | 0 |
| 11A a | 12.69 | −7.50 | 2.55 | +98 | 26.78 | +11058 |
| 12A a | 12.94 | −5.68 | 4.30 | +8500 | 45.38 | +18808 |
| 11A b | 10.42 | −24.05 | 15.47 | +30840 | 132.86 | +55258 |
| 12A b | 18.69 | +36.22 | 10.50 | +20900 | 154.00 | +64066 |

### Further Examples

Additional examples listed below further illustrate the processes and the cold-sintered ceramic polymer composites of the disclosure.

Example 1 is a structured cold-sintered ceramic composite that is made by a process comprising:
a. filling a plurality of open cells of an open cell substrate with (1) at least one inorganic compound that is in the form of particles having a number average particle size of less than about 30 μm and (2) a solvent in which the inorganic compound is at least partially soluble to obtain a filled-cell substrate, wherein the open cell substrate is comprised of at least one non-ceramic material; and
b. subjecting the filled-cell substrate to a pressure of no more than about 5000 MPa and a temperature (T₁) that is no greater than 200° C. above the boiling point of the solvent (as determined at 1 bar) to obtain a structured cold-sintered ceramic composite.

Example 2 includes example 1, wherein the process further comprises, prior to step (a), (a1) constructing an open cell substrate.

Example 3 includes example 2, wherein the constructing comprises one or more of molding, cutting, milling, and additive manufacturing.

Example 4 includes example 1, wherein the open cell substrate is in the form of a sheet having top and bottom surfaces and having a thickness of about 0.1 μm to about 1000 μm.

Example 5 includes example 1 or 2, wherein the cross-section of each open cell is the same shape.

Example 6 includes example 1 or 2, wherein the cross-sections of open cells constitute at least two different shapes.

Example 7 includes any one of examples 1-6, wherein the number average diameter of the open cell is about 0.1 μm to about 1000 μm.

Example 8 includes example 5 or 6, wherein each shape is selected from the group consisting of a polygon having 3 to 8 sides, a keyhole, a circle, and an ellipse.

Example 9 includes example 8, wherein the open cells are arranged in a repeating pattern.

Example 10 includes example 8, wherein the open cells are arranged in a random pattern.

Example 11 includes any one of examples 8-10, wherein the shape is a polygon selected from a triangle, square, rectangle, pentagon, hexagon, heptagon, and octagon.

Example 12 includes example 11, wherein the shape is a hexagon and the repeating pattern is a honeycomb.

Example 13 includes example 11, wherein the shape is a rectangle or square and adjoining open cells are offset with respect to each other in a brick-and-mortar pattern.

Example 14 includes example 11, wherein the shape is a rectangle and the open cells are aligned parallel to each other in a cornrow pattern.

Example 15 includes example 11, wherein the shape is a rectangle and the open cells are uniformly arranged in a cross-hatch pattern.

Example 16 includes example 11, wherein the shape is a circle and the open cells are not concentric.

Example 17 includes example 11, wherein the shape is a circle and each open cell is concentric with at least one other open cell.

Example 18 includes example 17, wherein all open cells of the open cell substrate are concentric.

Example 19 includes any one of examples 1-18, wherein the non-ceramic material is one selected from a metal, carbon, a polymer, and combinations thereof.

Example 20 includes any one of examples 1-19, wherein the non-ceramic material comprises a polymer P₁.

Example 21 includes example 20, wherein the polymer Pi has a melting point (Tₘ₁), if the polymer is crystalline or semi-crystalline, or a glass transition temperature (T_{g1}), if the polymer is amorphous, that is less than T₁.

Example 22 includes any one of examples 1-21, wherein the inorganic compound exists as a mixture with at least one polymer P₂ that has a melting point Tₘ₂, if the polymer is crystalline or semi-crystalline, or a glass transition temperature T_{g2}, if the polymer is amorphous, that is less than T₁.

Example 23 includes example 22, wherein Tₘ₂ or T_{g2} is lower than Tₘ₁ or T_{g1}, respectively.

Example 24 includes any one of examples 17-23, wherein P₁ and P₂ are independently selected from the group consisting of polyacetylenes, polypyrroles, polyanilines, poly(p-phenylene vinylene), poly(3-alkylthiophenes), polyacrylonitrile, poly(vinylidene fluoride), polyesters, polyacrylamides, polytetrafluoroethylene, polytrifluorochloroethylene, polytrifluorochloroethylene, perfluoroalkoxy alkanes, polyaryl ether ketones, polyarylene sulfones, polyaryl ether sulfones, polyarylene sulfides, polyimides, polyamidoimides, polyesterimides, polyhydantoins, polycycloenes, liquid crystalline polymers, polyarylensulfides, polyoxadiazobenzimidazoles, polyimidazopyrolones, polypyrones, polyorganosiloxanes, polyamides, acrylics, polycarbonate, polyetherether ketone, polyetherimide, polyethersulfone, polyethylene, polypropylene, polystyrene, polytetrafluoroethylene, polyurethanes, polyvinyl chloride, polyvinylidene difluoride, and sulfonated tetrafluoroethylene (Nafion), co-polymers thereof, and blends thereof.

Example 25 includes any one of examples 17-23, wherein P₁ and P₂ are different.

Example 26 includes any one of examples 1-25, wherein the weight percentage of the inorganic compound is about 50% to about 99% (w/w) based upon the total weight of the filled-cell substrate.

Example 27 includes any one of examples 1-26, wherein the solvent is selected from the group consisting of water, an alcohol, an ester, a ketone, a dipolar aprotic solvent, and combinations thereof.

Example 28 includes any one of examples 1-27, wherein the solvent comprises at least 50% water by weight, based upon the total weight of the solvent.

Example 29 includes any one of examples 1-28, wherein the solvent further comprises an inorganic acid, an organic acid, an inorganic base, or an organic base.

Example 30 includes any one of examples 1-29, wherein steps (a) and (b) are sequentially performed a multitude of times to obtain a corresponding multitude of single layer structured cold-sintered ceramic composites, and wherein the process further comprises (c) layering the single layer structured cold-sintered ceramic composites to obtain a cold-sintered multi-layer ceramic composite.

Example 31 includes example 30, wherein the cross-section of the cells is the same shape in all single layer structured cold-sintered ceramic composites.

Example 32 includes example 30, wherein a number percentage of single layer structured cold-sintered ceramic composites have cells that are different from the shape of cells in the remaining single layer structured cold-sintered ceramic composites.

Example 33 includes example 32, wherein the number percentage is about 5% to about 80%.

Example 34 includes any one of examples 30-33, wherein step (c) further comprises depositing a bonding layer of a curable adhesive, a curable epoxy, a polymer P₃, or a combination thereof between adjacent single layer structured cold-sintered ceramic composites, wherein P₃ has a melting point (Tₘ₃), if the polymer is crystalline or semi-crystalline, or a glass transition temperature (T_{g3}), if the polymer is amorphous, and wherein the process further comprises (d) subjecting the product of step (c) to a pressure of no more than about 5000 MPa and/or a temperature (T₂) that is above Tₘ₃ or T_{g3}.

Example 35 includes any one of examples 30-34, wherein the process further comprises one or more of milling and polishing the multi-layer composite.

Example 36 includes any one of examples 30-34, wherein each bonding layer has a thickness of about 0.1 μm to about 1000 μm.

Example 37 includes any one of examples 1-29, wherein step (a) is performed sequentially a multitude of times to obtain a corresponding multitude of single layer filled-cell substrates, wherein the process further comprises (b1) layering the multitude of single layer filled-cell substrates to obtain a multi-layer filled-cell substrate; and then step (b) is performed on the multi-layer filled-cell substrate to obtain a cold-sintered multi-layer composite.

Example 38 includes example 36, wherein the cross-section of the cells is the same shape in all single layer filled-cell substrates.

Example 39 includes example 38, wherein a number percentage of single layer filled-cell substrates have cells that are different from the shape of cells in the remaining single layer filled-cell substrates.

Example 40 includes example 39, wherein the number percentage is about 5% to about 80%.

Example 41 includes any one of examples 36-40, wherein the process further comprises (d) sintering the cold-sintered multi-layer ceramic composite.

Example 42 is a process for making a cold-sintered ceramic composite, comprising the steps of:
a. filling a plurality of open cells of an open cell substrate with (1) at least one inorganic compound that is in the form of particles having a number average particle size of less than about 30 μm and (2) a solvent in which the inorganic compound is at least partially soluble to obtain a filled-cell substrate, wherein the open cell substrate is comprised of at least one non-ceramic material; and
b. subjecting the filled-cell substrate to a pressure of no more than about 5000 MPa and a temperature (T₁) that is no greater than 200° C. above the boiling point of the solvent (as determined at 1 bar) to obtain a single layer structured cold-sintered ceramic polymer composite.

Example 43 includes example 42, wherein steps (a) and (b) are sequentially performed a multitude of times to obtain a corresponding multitude of single layer structured cold-sintered ceramic composites, and wherein the process further comprises (c) layering the single layer structured cold-sintered ceramic composites to obtain a cold-sintered multi-layer ceramic composite.

Example 44 includes example 43, wherein the process further comprises (d) sintering the cold-sintered multi-layer ceramic composite.

Example 45 includes example 42, wherein step (a) is performed sequentially a multitude of times to obtain a corresponding multitude of single layer filled-cell substrates, wherein the process further comprises (b1) layering the multitude of single layer single layer filled-cell substrates to obtain a multi-layer filled-cell substrate; and
then step (b) is performed on the multi-layer filled-cell substrate to obtain a cold-sintered multi-layer composite.

1. A structured cold-sintered ceramic composite that is made by a process comprising:
a. filling a plurality of open cells of an open cell substrate with (1) at least one inorganic compound that is in the form of particles having a number average particle size of less than about 30 μm and (2) a solvent in which the inorganic compound is at least partially soluble to obtain a filled-cell substrate, wherein the open-cell substrate is comprised of at least one non-ceramic material, and wherein each open cell includes a hole or cavity defined in the substrate material which is otherwise solid and monolithic, and each open cell has substantially parallel sidewalls perpendicular to an openings of the open cell at a corresponding surface of the substrate; and
b. subjecting the filled-cell substrate to a pressure of no more than about 5000 MPa and a temperature (T₁) that is no greater than 200° C. above the boiling point of the solvent (as determined at 1 bar) to obtain a structured cold-sintered ceramic composite.

2. The structured cold-sintered ceramic composite according to claim 1, wherein the process further comprises, prior to step (a):
a1. constructing an open cell substrate by a method comprising one or more processes selected from the group of processes consisting of: molding, cutting, milling, and additive manufacturing.

3. The structured cold-sintered ceramic composite according to claim 2, wherein the constructing comprises additive manufacturing.

4-7. (canceled)

8. The structured cold-sintered ceramic composite according to claim 1, wherein the open cells have a cross-sectional shape, and each shape is selected from the group consisting of a polygon having 3 to 8 sides, a keyhole, a circle, and an ellipse.

9-10. (canceled)

11. The structured cold-sintered ceramic composite according to claim 8, wherein the shape is a polygon selected from a triangle, square, rectangle, pentagon, hexagon, heptagon, and octagon.

12. The structured cold-sintered ceramic composite according to claim 11, wherein the shape is a hexagon and the repeating pattern is a honeycomb.

13. The structured cold-sintered ceramic composite according to claim 11, wherein the shape is a rectangle or square and adjoining open cells are offset with respect to each other in a brick-and-mortar pattern or are uniformly arranged in a cross-hatch pattern.

14-15. (canceled)

16. The structured cold-sintered ceramic composite according to claim 11, wherein the shape is a circle and the open cells are not concentric.

17-19. (canceled)

20. The structured cold-sintered ceramic composite according to claim 1, wherein the non-ceramic material comprises a polymer P₁ having a melting point (Tₘ₁), if the polymer is crystalline or semi-crystalline, or a glass transition temperature (T_{g1}), if the polymer is amorphous, that is greater than T₁.

21. (canceled)

22. The structured cold-sintered ceramic composite according to claim 1, wherein the inorganic compound exists as a mixture with at least one polymer P₂ that has a melting point Tₘ₂, if the polymer is crystalline or semi-crystalline, or a glass transition temperature T_{g2}, if the polymer is amorphous, that is less than T₁.

23-26. (canceled)

27. The structured cold-sintered ceramic composite according to claim 1, wherein the solvent is selected from the group consisting of water, an alcohol, an ester, a ketone, a dipolar aprotic solvent, and combinations thereof.

28-29. (canceled)

30. The structured cold-sintered ceramic composite according to claim 1, wherein steps (a) and (b) are sequentially performed a multitude of times to obtain a corresponding multitude of single layer structured cold-sintered ceramic composites, and wherein the process further comprises:
c. layering the single layer structured cold-sintered ceramic composites to obtain a cold-sintered multi-layer ceramic composite.

31-33. (canceled)

34. The structured cold-sintered ceramic composite according to claim 30, wherein step (c) further comprises depositing a bonding layer of a curable polymer, a polymer P₃, or a combination thereof between adjacent single layer structured cold-sintered ceramic composites, wherein P₃ has a melting point (Tₘ₃), if the polymer is crystalline or semi-crystalline, or a glass transition temperature (T_{g3}), if the polymer is amorphous, and wherein the process further comprises:
d. subjecting the product of step (c) to a pressure of no more than about 5000 MPa and/or a temperature (T₂) that is above Tₘ₃ or T_{g3}.

35-37. (canceled)

38. The structured cold-sintered ceramic composite according to claim 30, wherein each bonding layer has a thickness of about 0.1 μm to about 1000 μm.

39-42. (canceled)

43. The structured cold-sintered ceramic composite according to claim 1, wherein the process further comprises:
d. annealing the cold-sintered multi-layer ceramic composite.

44. A process for making a cold-sintered ceramic composite, comprising steps of:
a. filling a plurality of open cells of an open cell substrate with (1) at least one inorganic compound that is in the form of particles having a number average particle size of less than about 30 μm and (2) a solvent in which the inorganic compound is at least partially soluble to obtain a filled-cell substrate, wherein the open-cell substrate is comprised of at least one non-ceramic material; and
b. subjecting the filled-cell substrate to a pressure of no more than about 5000 MPa and a temperature (T₁) that is no greater than 200° C. above the boiling point of the solvent (as determined at 1 bar) to obtain a single layer structured cold-sintered ceramic polymer composite.

45. The process according to claim 44, wherein steps (a) and (b) are sequentially performed a multitude of times to obtain a corresponding multitude of single layer structured cold-sintered ceramic composites, and wherein the process further comprises:
c. layering the single layer structured cold-sintered ceramic composites to obtain a cold-sintered multi-layer ceramic composite.

46. The process according to claim 45, wherein the process further comprises:
d. annealing the cold-sintered multi-layer ceramic composite.

47. The process according to claim 44, wherein
step (a) is performed sequentially a multitude of times to obtain a corresponding multitude of single layer filled-cell substrates, wherein the process further comprises
(b1) layering the multitude of single layer filled-cell substrates to obtain a multi-layer filled-cell substrate; and then
step (b) is performed on the multi-layer filled-cell substrate to obtain a cold-sintered multi-layer composite.

48. A structured cold-sintered ceramic composite comprising:
a. an open cell substrate defining a plurality of open cells and being otherwise solid and monolithic, each open cell including a hole or cavity defined in the substrate material and having substantially parallel sidewalls perpendicular to an openings of the open cell at a corresponding surface of the substrate, the open cell substrate comprising at least one polymer P₁ having a melting point (Tₘ₁), if the polymer is crystalline or semi-crystalline, or a glass transition temperature (T_{g1}), if the polymer is amorphous; and
b. a mixture filling the open cells, the mixture comprising particles of inorganic material and at least one polymer P₂ that has a melting point Tₘ₂, if the polymer is crystalline or semi-crystalline, or a glass transition temperature T_{g2}, if the polymer is amorphous, the particles of inorganic material having a number average particle size of less than about 30 μm, where within each of the open cells the particles of inorganic material are cold-sintered together; and
where the cold-sintering has been achieved by subjecting the substrate and mixture to a temperature T₁ that is greater than Tₘ₂ or T_{g2}, as applicable to polymer P₂, but lower than Tₘ₁ or T_{g1}), as applicable to polymer P₁.
